(19) United States
(12) Patent Application Publication
(10) Pub. No.: US 2007/0258604 A1
(43) Pub. Date: Nov. 8, 2007

(54) Audiovisual Arrangement

(76) Inventor: Robert Bosnecker, Ergolding (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/631,464

(22) PCT Filed: Jun. 29, 2005
(86) PCT No.: PCT/EP05/53069

§ 371 Date: Jan. 3, 2007

(30) Foreign Application Priority Data
Jul. 2, 2004 (DE) 10 2004 032 223.6

(51) Int. Cl. H04R 7/04

(52) U.S. Cl. 381/152

(57) ABSTRACT

The invention relates to an audiovisual arrangement comprising a planar element that is embodied for representing image data and can be triggered to emit light and a planar, rigid element which is configured for generating sound data and can be excited to perform transversal bending vibrations and thus emit sound. In order to be able to configure devices comprising generic audiovisual arrangements in a particularly compact fashion while dispensing with components if necessary, the sound-generating element is embodied substantially coextensive to the light-emitting element.

The invention relates to an audiovisual arrangement as claimed in the preamble of claim 1.

By contrast with conventional loudspeaker boxes, which feature a plurality of individually-designed loudspeaker units with sound-generating membranes, the audio part of an inventive arrangement has one flat-panel loudspeaker in which a planar element with sufficient rigidity can be excited to perform transversal bending vibrations and thus to emit sound. Such a sound-generating element for output of sound information is known per se and is disclosed for example in the application DE 199 17 584 A1. A plurality of possible applications are known for this type of generic electro-acoustic converter.

Loudspeakers are known from European patents EP 0 847 669 B1, EP 0 847 670 B1 and EP 0 847 671 B1 which have a component with the capability to maintain injected vibration energy and to propagate it by bending waves in at least one effective plane running transversely to the thickness, which distributes resonance-mode vibration components over this surface. Converters are attached to the component at positions within this surface predetermined by calculations to make it start to vibrate and allow it to resonate. In such cases an acoustic generator is created which delivers an acoustic output signal when it vibrates into resonance. The component features a rigid light panel with a core which is covered on both sides by surface layers. The core consists for example of hard plastic foam or of a cellular matrix, whereas the surface layers consist of paper, card, plastic, a metal foil or tin. The panel is held around its circumference by a sprung suspension support, e.g. a foam rubber surround, which in its turn is held in a light frame running all around it, made of aluminum or plastic for example.

As a result of the limited choice of materials suitable for such loudspeakers, it has previously been necessary to either integrate the loudspeaker in the sidewalls of the housing of a computer monitor (EP 0 847 669 B1), or to accommodate it in a component containing the screen of laptop computer designed for moving or hinging the screen between a storage position and a operating position (EP 0 847 671 B1), or to embody it as a projection screen for images of a moving image projector of an audiovisual multimedia system (EP 0 847 670 B1).

The disadvantage of the previously known audiovisual arrangements is that, in addition to the planar elements embodied for presentation of picture information, one or more additional flat-panel loudspeakers must also be accommodated. This results in the audiovisual arrangement occupying a large amount of space, which is frequently undesirable.

The underlying object of the invention is thus to provide an arrangement of the type described at the start which is the simplest possible design and occupies very little space.

The object is achieved if, with an audiovisual arrangement with a planar element embodied for presentation of picture information, which can be triggered for light emission, and with a planar, rigid element embodied for output of sound information which is able to be excited for transversal bending vibrations and thus for sound emission, the sound-generating element is embodied substantially coextensive to the light-emitting element. A coextensive embodiment of the two planar elements, i.e. one which extends over the same surface area, produces a more compact design of audiovisual circuit arrangements. Sound and picture information are emitted for the listener or the viewer from the same planar source, thus essentially they have the same origin. The light-emitting element in this case is taken to mean an optically active surface which does not merely reflect light shone onto it, which is what a projector screen or similar does. This enables the elements embodied for presentation of picture information and for output of sound information to be integrated into one device, with the space savings achieved by the coextensive embodiment of the planar elements being particularly advantageous for small devices. In addition the substantially coextensive embodiment of the elements provides the option of saving on entire components.

In a preferred embodiment of the inventive arrangement the sound-generating element is embodied as a carrier layer for the light-emitting element. The two planar elements essentially extend here over the same surface area, but do not lie in the same geometrical plane. This layer structure is for example advantageous if the material of the light-emitting element does not have sufficient rigidity to function as a sound-generating element. The light-emitting element is then accommodated directly or in a sandwich construction with functional intermediate layers on a sound-generating element with suitable rigidity.

In an alternative preferred embodiment of the inventive arrangement the sound-generating element is formed by the light-emitting element itself. If a material with high rigidity is used for the light-emitting element, this can also be excited to transversal bending vibrations and thus to generate sound. In this case the planar elements essentially extend over the same surface area and lie in the same geometrical plane, thus being integrated into one common component. This one-piece design of an element which is embodied for presentation of picture information and simultaneously for emission of sound information opens up additional design freedoms for generic audiovisual arrangements.

In an advantageous embodiment of the inventive arrangement the light-emitting element features a layer made of organic light-emitting diodes. The underlying cell structure of organic light-emitting diodes, abbreviated to OLEDs, consists of a stack of thin organic layers which are arranged in a sandwich construction between a transparent anode and a metallic cathode. The provision of these types of organic transistors made of polymer foils makes it possible to manufacture thin, large-surface and simultaneously flexible display elements, which can emit light in a controlled manner using electroluminescence. Also conceivable is the use of other flexible screens, consisting of a special plastic for example which illuminates when a voltage is applied. OLEDs can be applied both on a carrier layer embodied as a sound-generating element, and can also be used as flexible, rigid element which can be excited for sound generation.

In a preferred embodiment of the inventive arrangement at least one electromagnetic signal converter is assigned to the sound-generating element, which converts audio signals fed to it into mechanical vibrations, by means of which the sound-generating element can be excited to transversal bending vibrations. Depending on size and form of the sound-generating element as well as depending of the surrounding peripheral conditions one, preferably a number of electromechanical converters, to which the audio signals of a sound carrier are fed as electrical input signals, are connected by means of an adhesive technique to the sound-generating element, for example. The electromechanical converters possibly embodied as vibrating coils transform the audio signals into mechanical vibrations which are transmitted to the sound-generating element. This excites the sound-generating element to transversal bending vibrations, whereby the sound information corresponding to the audio signals is output by the element.

Preferably the at least one converter has an electronic signal processing unit connected upstream from it, by means of which the non-linearities in the acoustic transmission characteristics of the sound-generating element can be compensated for. The frequency response of a flat-panel loudspeaker used here is defined by the mechanical characteristics of the sound-generating element as well as by number and position of the converters accommodated on it. This frequency response typically exhibits non-linearities which lead to a sound distortion when sound is generated in specific frequency ranges. So that the sound-generating element can output tones and sounds without distortion, an electronic signal processing unit is connected upstream from the converters, in which the audio signals are filtered depending on frequency, in order to provide an overall acoustic system with a linear transmission characteristic.

In an advantageous embodiment of the inventive arrangement the electronic signal processing unit features a digital signal processor which is embodied to store the transmission function of the sound-generating element as well as to preprocess the audio signals fed to it in the frequency response corresponding to the inverse amplitude value of this transmission function. The use of a digital signal processor for electronic preprocessing of the audio signals allows the storage of previously transferred transmission functions of the system comprising sound-generating element and electromechanical converters accommodated on it. Thus for each configuration, initially dependent on material, size, thickness and mounting conditions of the element as well as number, type and position of the converter, this configuration's own acoustic transmission function can be determined. This transmission function is stored in the memory of the digital signal processor, with the signal processor being able to be programmed such that audio signals fed to it are filtered in accordance with the inverse of the stored transmission function, whereby non-linearities in the transmission function are compensated for. This provides the designer of audiovisual circuit arrangements with a plurality of combinations of sound-generating elements and converters, which can also fully satisfy demanding audio requirements—even Hi-Fi.

In a further advantageous embodiment of the inventive arrangement, an infrared or radio transmission link is provided for signal transmission between the electronic signal processing unit and an output amplifier connected upstream of the at least one converter. If, due to lack of space for example, the audiovisual arrangement is forced not to accommodate the signal processing unit in the immediate vicinity of the sound-generating element and connection by means of audio cables is not easily possible or is too expensive to construct, the preprocessed audio signals can be transmitted wirelessly via radio or infrared beam. The received audio signals are however amplified in an upstream output amplifier before being fed to the at least one electromechanical converter. Thus for example the signal processing unit could be arranged directly at the sound generator, for example DVD player or tuner, with the output amplifier being arranged in the device featuring the sound-generating element.

Advantageously the inventive audiovisual arrangement can then be used in a mobile radio device, personal computer or laptop screen, multimedia device, Hi-Fi unit, measuring device, kitchen appliance, Personal Digital Assistant or such like. The versatility of the application essentially extends to all audiovisual circuit arrangements which feature planar elements both for presentation of picture information and also for generation of sound information.

An exemplary embodiment as well as further advantages of the invention are subsequently explained with reference to the drawings, in which

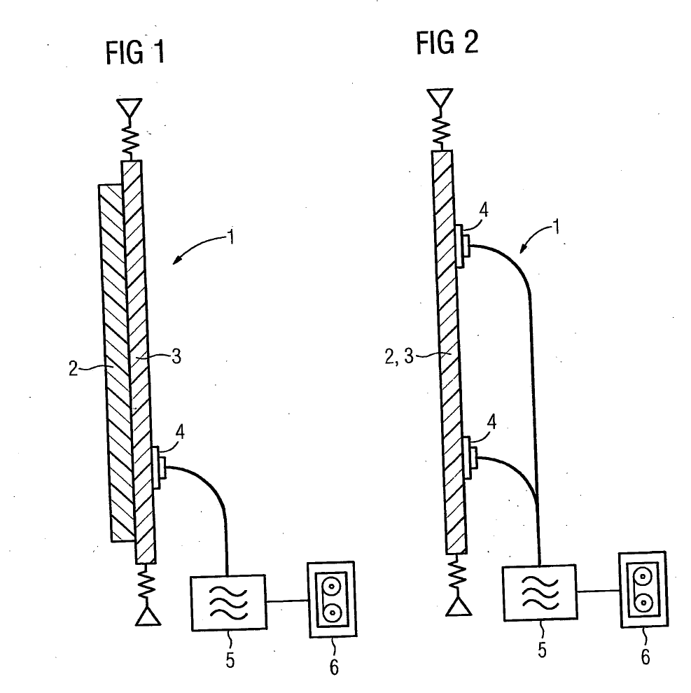

FIG. 1 shows a first exemplary embodiment of an inventive audiovisual arrangement, in which the sound-generating element is embodied as a carrier layer for the light-emitting element,

FIG. 2 shows a second exemplary embodiment of an inventive audiovisual arrangement, in which the sound-generating element is formed by the light-emitting element itself,

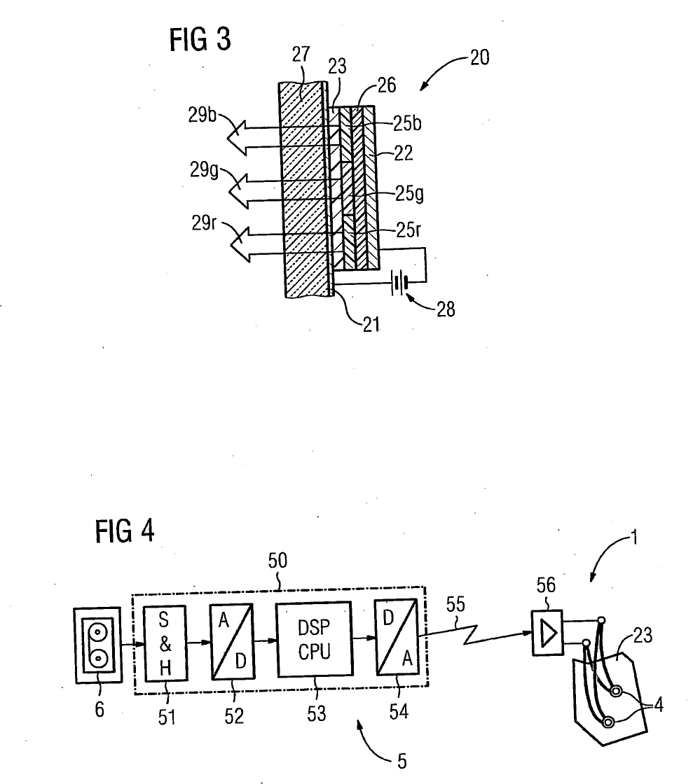

FIG. 3 shows a cross-sectional diagram of a organic light-emitting diode as a detail of the cell structure of the light-emitting element, and

FIG. 4 shows a block diagram to illustrate the signal processing for audio signals which are emitted by a sound generator and fed to converters of an inventive audiovisual arrangement,

as schematic diagrams.

In accordance with FIG. 1 and FIG. 2, an audiovisual arrangement 1, for example a mobile radio device, a personal computer or a laptop, a multimedia device, a Hi-Fi unit, a measuring device, a kitchen appliance, a Personal Digital Assistant or such like, features a planar element 2 for presentation of picture information which is able to be triggered for light emission, and for output of sound information features a planar, rigid element 3, which can be excited to transversal bending vibrations and thus to generate sound. In the exemplary embodiment of the audiovisual arrangement 1 shown, the sound-generating element 3 is at least partly clamped at its edge, as is usual with screen and display units in housings of the said devices. The sound-generating element 3 is embodied as a thin, rigid plate, attached to the surface of which is at least one electromechanical converter 4. The electromechanical converter or converters 4 are triggered by a sound generator 6, so that the converter 4 oscillates mechanically in accordance with the audio signal of the sound generator and, by its attachment to the sound-generating element 3, excites the latter to transversal bending vibrations. If the element 3 starts to resonate when executing transversal bending vibrations, the sound-generating element 3 generates tones and sounds. To obtain a transmission characteristic of the system comprising converters 4 and sound-generating element 3 and light-emitting element 2 in the frequency response which is as linear as possible, the sound signals of the sound generator 6 are first fed to a signal processing unit 5, of which the structure and function is explained in greater detail with reference to FIG. 4. In accordance with the invention the sound-generating element 3 is embodied substantially coextensive to the light-emitting element 2. This achieves an especially compact design of terminals of the above-mentioned type, since the loudspeaker essentially extends over the same surface area as the screen.

In the embodiment shown in FIG. 1 the sound-generating element 3 is embodied as a carrier layer for the light-emitting element 2. The planar element 2, which is embodied for presentation of picture information, is arranged here in parallel to the planar element which is embodied for output of sound information and is attached to the latter. This embodiment is advantageous if the light-emitting element 2 alone does not have sufficient rigidity to serve as a sound-generating element 3. However, if it does, as shown in the exemplary embodiment in FIG. 2, the sound-generating element 3 can be formed by the light-emitting element 2 itself. Thus both functions, namely the reproduction of picture and sound information, are implemented by one and the same planar element 2 or 3. This enables the audiovisual circuit arrangements 1 of the above-mentioned devices to be manufactured even flatter and more simply. The light-emitting element 2 can for example be made of a foil of organic light-emitting diodes 20 (cf. FIG. 3) which even today can be manufactured in roll-up or foldable form and with sufficient rigidity for use as sound emitters.

With light-emitting foils made of organic light-emitting diodes 20, or OLEDs for short, a distinction is made between an active and a passive matrix structure. In accordance with FIG. 3. an underlying OLED cell 20 comprises a stack of thin organic layers which are arranged in a sandwich construction between a transparent anode 21, made of indium-tin oxide in a transverse strip structure, and a metallic cathode 22. The organic layers feature a hole injection layer 23, a hole transport layer, a layer of adjacent strips of organic emitters for blue 25b, for green 25g and for red 25r, and an electron transport layer 26. If a suitable direct current voltage of between 2 and 10V is applied by the voltage source 28 between anode 21 and cathode 22, the injected positive charges (holes) and negative charges (electrons) recombine in the layer 25 with organic emitters to create light via electroluminescence. The created light in blue 29b, in green 29g and in red 29r escapes through a glass substrate layer 27, in which case, by explicit triggering of the individual OLED-cells 20 on the foil 2, picture information can be presented in color both statically and with content that can be changed over time.

The decisive aspect of the present invention is now that the coextensive format of the light-emitting element 2 and of the sound-generating element 3 has a sufficiently high rigidity to be excited by electromechanical converters 4 into transversal bending vibrations to form a flat-panel loudspeaker so that it can emit sound. As a result of the plurality of conceivable materials and material combinations combined with the plurality of differently positioned electromechanical converters 4, which are preferably embodied by vibrating coils operating in accordance with the electrodynamic principle, an equally large number of different transmission characteristics exists. Added to this are the widest variety of dimensions and general conditions (mounting of these vibrating systems), which all feature more or less severe non-linearities in their transmission function, which lead to known sound distortions. To correct these transmission errors an electronic signal processing unit 5 is proposed in accordance with the invention, which, as shown in FIG. 4, is fed the audio signals of a sound generator 6, for example of an analog reel-to-reel tape or cassette device. Alternatively the sound generator 6 can however also be a CD or DVD player, in which case the corresponding components of the signal conversion from analog to digital and vice versa can be dispensed with. Components of the signal processing unit 5 grouped together in a housing 50 especially represent an electronic filter of which the transmission function is embodied as inverse to the frequency response of the transmission characteristics of the audiovisual arrangement 1. The signal processing unit 5 possesses as its input circuit a sampling/holding element 51, frequently also referred to as a “sample & hold” circuit. With this element the audio signal fed from the tone generator 6 as an analog signal is sampled in accordance with a predetermined sampling theory. The instantaneous value sampled in each case is buffered and offered to an analog-digital converter 52. This converts the instantaneous values of the audio signal offered as serial values into digital signals expressed in binary. The digital signals are fed to a digital signal processor 53 or a CPU, in which the signal transformation required for correction of the frequency response is executed purely computationally. A digital-analog converter 54 is connected to the output of the signal processor 53, with which the binary output signal of the signal processor 53 is converted back into an analog signal. This analog signal is fed via an output stage 56 embodied as an output amplifier to the electromechanical converter 4 or also to a number of electromechanical converters 4, in parallel in the latter case.

The embodiment of the signal processing unit 5 shown in FIG. 4 advantageously uses advances in the development of digital signal processing. Powerful digital signal processors have also been widely used for some time now for real time applications. Familiarity with digital signal processors, the options for using them and embodiments for achieving individual functions can be taken as known here. In the schematic diagram depicted in FIG. 4 therefore the circuit layout of the digital signal processor 53 or of a CPU which can be used as an alternative is not specified in detail. Usually a signal processor, in addition to a microcontroller, possesses the actual control unit, a program, a data memory and an input/output memory, with these units being interconnected via a field bus system with parallel address, control and data lines. The option of storing a program tailored to an individual application in the program memory makes the signal processor 53 capable of being a universally applicable electronic circuit. In the present case it is advantageous to implement the filter or filters in the form of FIR (Finite Impulse Responder) filtering with which very complex transmission functions can be realized with real time requests in a known manner. Within the framework of the present solution the signal processing unit 5 can if necessary comprise a number of signal processors 53, which then operate in parallel mode, where very high demands are imposed on the transmission quality of the audiovisual arrangement 1. In this context it should be further noted that the connection between the output of the housing 50 of the signal processing unit 5 and the output stage 56 does not necessarily have to be embodied as an electrical line. As the exemplary embodiment depicted in FIG. 4 shows, it can be advantageous to provide a radio link 55, for example an infrared beam, as the connection between the housing 50 of the signal processing unit 5 and the output amplifier 56. This is especially advantageous, if, for constructional reasons, the housing 50 of the signal processing unit 5 cannot be placed in the immediate vicinity of the audiovisual arrangement 1, i.e. of the planar elements 2 or 3 and the converters 4, attached to them.

1.-7. (canceled)

8. An audiovisual arrangement, comprising:
a light-emitting planar element configured for representing image information; and
a sound-generating rigid planar element arranged substantially coextensive to the light-emitting element where the sound-generating element is vibratorily excited to generate an acoustic sound emission, wherein the sound-generating element is formed by the light-emitting element.

9. The arrangement as claimed in claim 8, wherein the light-emitting element comprises a layer of organic light-emitting diodes.

10. The arrangement as claimed in claim 9, wherein the sound-generating element is assigned at least one electromechanical converter that converts an electrical input audio signal into mechanical vibrations that vibratorily excite the sound-generating element to produce transversal bending vibrations of the sound-generating element.

11. The arrangement as claimed in claim 10, further comprising an electronic signal processing unit connected upstream from the at least one converter where the processing unit compensates for non-linearities in an acoustic transmission characteristic of the sound-generating element.

12. The arrangement as claimed in claim 11, wherein the electronic signal processing unit comprises a digital signal processor that stores a transmission function of the sound-generating element and pre-processes the audio signal in a frequency response corresponding to an inverse amplitude value of the stored transmission function.

13. The arrangement as claimed in claim 12, wherein an infrared or radio transmission link is provided for a transmission of signals between the electronic signal processing unit and an output amplifier connected upstream of the at least one converter.

14. The arrangement as claimed in claim 13, wherein the audiovisual arrangement is selected from the group consisting of: a mobile radio device, personal computer display, laptop screen, multimedia device, Hi-Fi unit, measuring device, kitchen appliance, and Personal Digital Assistant.

15. A method for providing an audiovisual arrangement, comprising:
providing a light-emitting planar element configured for representing image information;
arranging a sound-generating rigid planar element substantially coextensive to the light-emitting element;
exciting the sound-generating element to produce transversal bending vibrations in the sound-generating element; and
generate acoustic sound emissions by excited transversal bending vibrations of the sound-generating element, wherein the sound-generating element is formed by the light-emitting element.

16. The method as claimed in claim 15, wherein the light-emitting element comprises a layer of organic light-emitting diodes.

17. The method as claimed in claim 16, wherein the sound-generating element is assigned at least one electromechanical converter that converts an electrical input audio signal into mechanical vibrations that vibratorily excite the sound-generating element to produce transversal bending vibrations of the sound-generating element.

18. The method as claimed in claim 17, further comprising an electronic signal processing unit connected upstream from the at least one converter where the processing unit compensates for non-linearities in an acoustic transmission characteristic of the sound-generating element.

19. The method as claimed in claim 18, wherein the electronic signal processing unit comprises a digital signal processor that stores a transmission function of the sound-generating element and pre-processes the audio signal in a frequency response corresponding to an inverse amplitude value of the stored transmission function.

20. The method as claimed in claim 19, wherein an infrared or radio transmission link is provided for a transmission of signals between the electronic signal processing unit and an output amplifier connected upstream of the at least one converter.

21. The method as claimed in claim 20, wherein the audiovisual arrangement is selected from the group consisting of: a mobile radio device, personal computer display, laptop screen, multimedia device, Hi-Fi unit, measuring device, kitchen appliance, and Personal Digital Assistant.
